(19) United States
(12) Patent Application Publication
(10) Pub. No.: US 2016/0226139 A1
(43) Pub. Date: Aug. 4, 2016

(54) Inverted F-Type Array Antenna Having Structure for Isolation Improvement

(71) Applicant: Korea Advanced Institute of Science and Technology, Daejeon (KR)

(72) Inventors: Jong Won Yu, Daejeon (KR); Duk Soo Kwon, Daejeon (KR); Kwang Seok Kim, Daejeon (KR); Dong Jin Lee, Daejeon (KR)

(21) Appl. No.: 14/620,726

(22) Filed: Feb. 12, 2015

(30) Foreign Application Priority Data
Feb. 3, 2015 (KR) 10-2015-0017026

(51) Int. Cl. H01Q 1/52

(52) U.S. Cl. CPC H01Q 1/523

(57) ABSTRACT

A system and a method are provided that are capable of providing map data for supporting a variety of user network environments and selecting data zones freely. A navigation terminal includes a reception unit adapted to receive a file in which map data of a specific zone is stored, from a map provision server; and an execution unit adapted to execute a navigation function on the specific zone using the file. The file is produced by an individual unit with respect to each of geographic areas divided by a mesh unit having a variable size. The size of the mesh unit is decided according to the amount of information included in the geographic area such that the file has an equalized size.

### CROSS-REFERENCE TO RELATED APPLICATION

This application claims the benefit under 35 U.S.C. §119 of Korean Patent Application No. 10-2015-0017026, filed Feb. 3, 2015, which is hereby incorporated by reference in its entirety.

### BACKGROUND

Embodiments of the inventive concept described herein relate to a technology on an inverted F-type array antenna having a structure for improving isolation, and more particularly, relate to a technology for preventing interference between inverted F-type antennas include in the inverted F-type array antenna.

In recent years, as a mobile terminal such as a portable smart device has increased, data traffic that a communication service requires will increase ten times within the next coming years as compared with a system capacity of 1 Gbps that a conventional IEEE 802.16ac or an LTE-Advanced communication method provides.

Accordingly, a mobile terminal utilizes various frequencies to provide a stable communication service and is equipped with an array antenna, formed of a set of antennas fit to respective frequencies, to exchange information using wireless signals of various frequencies.

Since such a conventional array antenna is disposed to fit to a mobile terminal with a restricted size, interference occurs between antennas included in the array antenna. Moreover, the quality of communication service is lowered due to interference between wireless signals transmitted and received through the antennas.

To prevent the interference, the conventional array antenna is configured such that antennas are spaced apart from each other over a distance corresponding to half the wavelength of an operating frequency, thereby causing a decrease in the degree of integration.

Accordingly, in this specification, there is provided a technique for integrating a plurality of antennas in a restricted space (e.g., a space smaller than half the wavelength of an operating operation) while maintaining the quality of communication service, by preventing interference between antennas.

### BRIEF SUMMARY

Embodiments of the inventive concepts provide an inverted F-type array antenna in which a slot where at least one capacitor is disposed at a region between inverted F-type antennas.

In particular, embodiments of the inventive concepts provide an inverted F-type array antenna for preventing interference between the inverted F-type array antennas, by generating a resonance frequency equal to frequencies that inverted F-type array antennas radiate, the slot where the at least one capacitor is disposed.

At this time, embodiments of the inventive concepts provide an inverted F-type array antenna where the at least capacitor or the slot is adjusted such that there is generated a resonance frequency equal to frequencies that inverted F-type array antennas radiate.

Moreover, embodiments of the inventive concepts provide a structure of an array antenna capable of preventing interference and applicable to various array antennas as well as the inverted F-type array antenna.

One aspect of embodiments of the inventive concept is directed to provide an inverted F-type array antenna having a structure for isolation improvement. The inverted F-type array antenna may include a substrate, a first inverted F-type antenna, and a second inverted F-type antenna. The first inverted F-type antenna may be formed on an upper surface of the substrate toward a first direction of directions parallel with the upper surface of the substrate. The second inverted F-type antenna may be formed on the upper surface of the substrate toward a second direction, opposite to the first direction, from among the directions parallel with the upper surface of the substrate, so as to be mirrored with respect to the first inverted F-type antenna. A slot where at least one capacitor for preventing interference between the first inverted F-type antenna and the second inverted F-type antenna is disposed may be formed at a region between the first inverted F-type antenna and the second inverted F-type antenna of the upper surface of the substrate.

The slot where the at least one capacitor is disposed may generate a resonance frequency equal to a frequency which at least one of the first inverted F-type antenna or the second inverted F-type antenna radiates, to prevent the interference between the first inverted F-type antenna and the second inverted F-type antenna.

A value of the at least one capacitor may be adjusted such that there is generated a resonance frequency equal to a frequency which at least one of the first inverted F-type antenna or the second inverted F-type antenna radiates.

At least one of a size of the at least one capacitor or the number of capacitors disposed at the slot may be adjusted such that there is generated a resonance frequency equal to a frequency which at least one of the first inverted F-type antenna or the second inverted F-type antenna radiates.

A depth of the slot where the at least one capacitor is disposed may be adjusted such that there is generated a resonance frequency equal to a frequency which at least one of the first inverted F-type antenna or the second inverted F-type antenna radiates.

The slot where the at least one capacitor is disposed may match impedance between the first inverted F-type antenna and the second inverted F-type antenna.

When the inverted F-type array antenna is disposed in plurality on the upper surface of the substrate, at least one slot where at least one capacitor is disposed may be formed at a region between the plurality of inverted F-type array antennas of the upper surface of the substrate, to separate the plurality of inverted F-type array antennas physically.

Each of the first inverted F-type antenna and the second inverted F-type antenna may include a ground element electrically connected with the substrate; a feeding element formed to be adjacent to the ground element and configured to transfer a feeding signal; and a radiation element electrically connected with the ground element and the feeding element, extending in the first direction or the second direction, and configured to radiate a wireless signal.

The upper surface of the substrate may be formed to have a plane, a circle, or a polygon.

Another aspect of embodiments of the inventive concept is directed to provide an array antenna having a structure for isolation improvement. The array antenna may include a substrate, a first antenna, and a second antenna. The first antenna may be formed on an upper surface of the substrate toward a first direction of directions parallel with the upper surface of the substrate. The second antenna may be formed on the upper surface of the substrate toward a second direction, opposite to the first direction, from among the directions parallel with the upper surface of the substrate, so as to be mirrored with respect to the first antenna. A slot where at least one capacitor for preventing interference between the first antenna and the second antenna is disposed may be formed at a region between the first antenna and the second antenna of the upper surface of the substrate.

The slot where the at least one capacitor is disposed may generate a resonance frequency equal to a frequency which at least one of the first antenna or the second antenna radiates, to prevent the interference between the first antenna and the second antenna.

### BRIEF DESCRIPTION OF THE DRAWINGS

The above and other objects and features will become apparent from the following description with reference to the following figures, wherein like reference numerals refer to like parts throughout the various figures unless otherwise specified, and wherein

FIG. 1 is a cross-sectional view illustrating an inverted F-type array antenna according to an exemplary embodiment of the inventive concept;

FIG. 2 is a cross-sectional view illustrating inverted F-type array antennas according to an exemplary embodiment of the inventive concept; and

FIGS. 3 and 4 are cross-sectional views illustrating inverted F-type array antennas disposed in various shapes, according to an exemplary embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

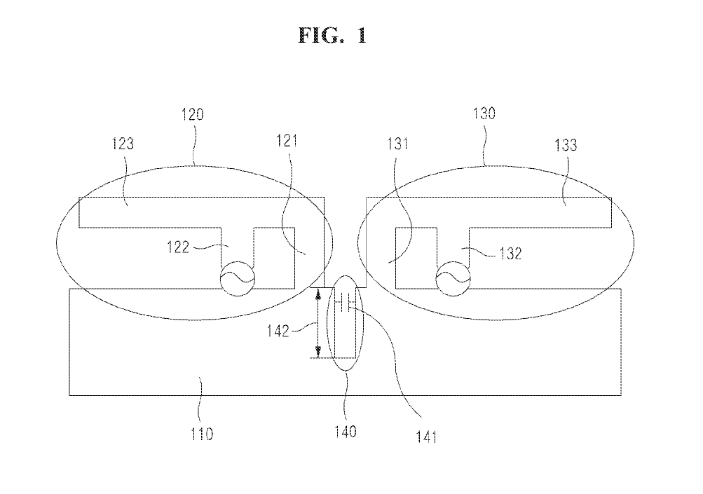

FIG. 1 is a cross-sectional view illustrating an inverted F-type array antenna according to an exemplary embodiment of the inventive concept.

Referring to FIG. 1, an inverted F-type array antenna according to an exemplary embodiment of the inventive concept contains a substrate 110, a first inverted F-type antenna 120, and a second inverted F-type antenna 130.

The first inverted F-type antenna 120 is formed on an upper surface of the substrate 110 toward a first direction of directions parallel with the upper surface of the substrate 110. Here, the first inverted F-type antenna 120 includes a ground element 121 electrically connected with the substrate 110, a feeding element 122 formed to be adjacent to the ground element 121 and configured to transfer a feeding signal, and a radiation element 123. The radiation element 123 is electrically connected with the ground element 121 and the feeding element 122, extends in the first direction, and radiates a wireless signal.

The second inverted F-type antenna 130 is formed on the upper surface of the substrate 110 toward a second direction, opposite to the first direction, from among the directions parallel with the upper surface of the substrate 110, so as to be mirrored with respect to the first inverted F-type antenna 120. Here, the second inverted F-type antenna 130 includes a ground element 131 electrically connected with the substrate 110, a feeding element 132 formed to be adjacent to the ground element 131 and configured to transfer a feeding signal, and a radiation element 133. The radiation element 133 is electrically connected with the ground element 131 and the feeding element 132, extends in the first direction, and radiates a wireless signal.

A slot 140 is formed at a region that belongs to the upper surface of the substrate 110 and is placed between the first inverted F-type antenna 120 and the second inverted F-type antenna 130. Here, at least one capacitor 141 is disposed at the slot 140.

The slot 140 where the at least one capacitor 141 is disposed generates a resonance frequency equal to a frequency that at least one of the first inverted F-type antenna 120 or the second inverted F-type antenna 130 radiates, thereby preventing interference between the first inverted F-type antenna 120 or the second inverted F-type antenna 130.

Accordingly, a value of the at least one capacitor 141 is adjusted such that there is generated a resonance frequency equal to a frequency that at least one of the first inverted F-type antenna 120 or the second inverted F-type antenna 130 radiates.

Moreover, the number of capacitors to be disposed in the slot 140 is adjusted such that there is generated a resonance frequency equal to a frequency that at least one of the first inverted F-type antenna 120 or the second inverted F-type antenna 130 radiates. The size of the at least one capacitor 141 is also adjusted such that there is generated a resonance frequency equal to a frequency that at least one of the first inverted F-type antenna 120 or the second inverted F-type antenna 130 radiates.

A resonance frequency generated from the slot 140 where the at least one capacitor 141 is disposed is proportional to a length of a current path of the substrate 110 where the slot 140 is formed. For this reason, a depth 142 of the slot 140 where the at least one capacitor 141 is disposed is adjusted such that there is generated a resonance frequency equal to a frequency that at least one of the first inverted F-type antenna 120 or the second inverted F-type antenna 130 radiates.

Here, the slot 140 where the at least one capacitor 141 is disposed not also generates a resonance frequency equal to a frequency that at least one of the first inverted F-type antenna 120 or the second inverted F-type antenna 130 radiates, but it matches impedance between the first inverted F-type antenna 120 and the second inverted F-type antenna 130.

To sum up, the inverted F-type array antenna has an isolation-improved structure that includes the slot 140 where the at least one capacitor 141 is disposed and formed at a region between the first inverted F-type antenna 120 and the second inverted F-type antenna 130 of the upper surface of the substrate 110, thereby preventing interference between the first inverted F-type antenna 120 and the second inverted F-type antenna 130. For example, the isolation-improved structure may secure isolation over 10B as compared with a conventional array antenna. Accordingly, the inverted F-type array antenna according to an exemplary embodiment of the inventive concept maintains the quality of communication service and is integrated in a small space (e.g., a space within one-eighth of the wavelength of an operating frequency).

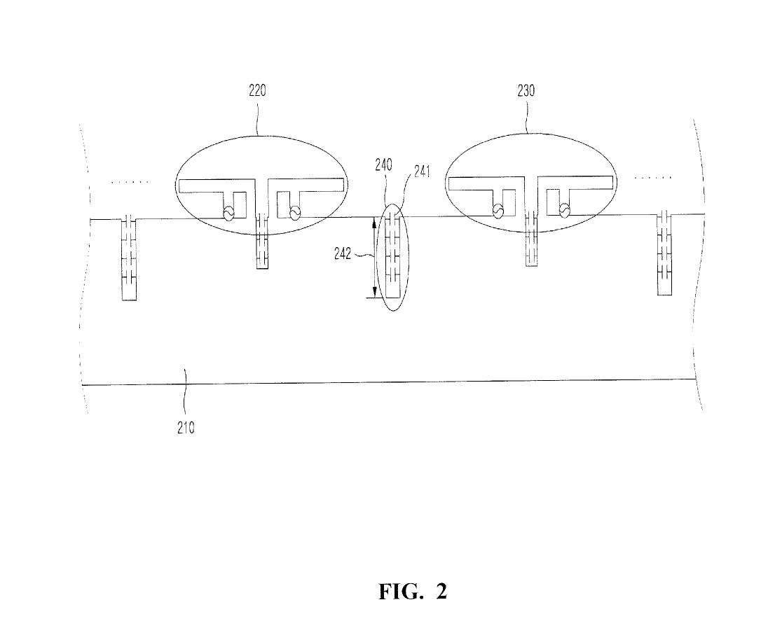

In the event that the inverted F-type array antenna is disposed in plurality on the upper surface of the substrate 110, at least one slot where at least one capacitor is disposed may be additionally formed on the upper surface of the substrate 110 to separate a plurality of inverted F-type array antennas physically. This will be more fully described with reference to FIG. 2.

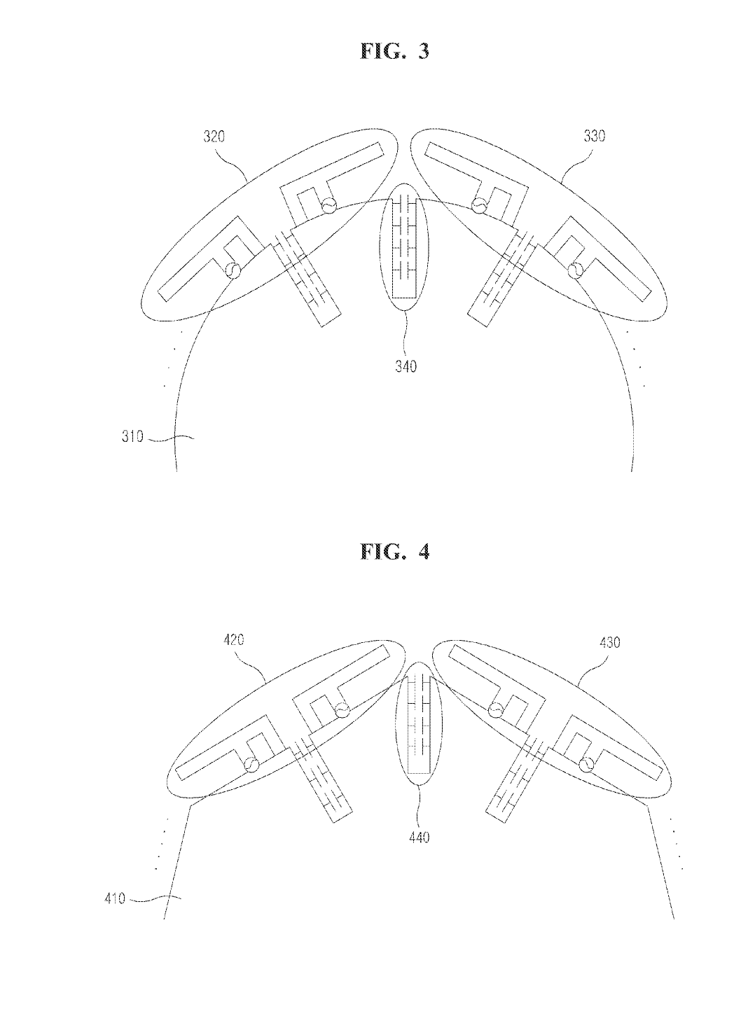

Also, the inverted F-type array antenna may be disposed in various shapes such as a plane, a circle, and a polygon. This will be more fully described with reference to FIGS. 3 and 4.

Although not shown, the above-described structure for improving isolation may be applied to various array antennas as well as the inverted F-type array antenna.

For example, in the event that a structure of the above-described inverted F-type array antenna is applied to an array antenna including an antenna such as an inverted L-type antenna, the array antenna may be configured to include a substrate; a first antenna formed on the substrate toward a first direction of directions parallel with an upper surface of the substrate; and a second antenna formed on the upper surface of the substrate toward a second direction, opposite to the first direction, so as to be mirrored with respect to the first antenna. A slot where at least one capacitor is disposed to prevent interference between the first and second antennas may be formed at a region between the first and second antennas of the upper surface of the substrate.

Likewise, the slot where the at least one capacitor is disposed may generate a resonance frequency equal to a frequency that at least one of the first antenna or the second antenna radiates, thereby preventing interference between the first and second antennas.

At this time, a value and the size of the at least one capacitor and the number of capacitors to be disposed in the slot may be adjusted such that there is generated a resonance frequency equal to a frequency that at least one of the first antenna or the second antenna radiates. A depth of the slot where the at least one capacitor is disposed may be also adjusted such that there is generated a resonance frequency equal to a frequency that at least one of the first antenna or the second antenna radiates.

Accordingly, the array antenna having such a structure may prevent interference between the first antenna and the second antenna while maintaining the quality of communication service and may be integrated in a small space (e.g., a space within one-eighth of the wavelength of an operating frequency).

FIG. 2 is a cross-sectional view illustrating inverted F-type array antennas according to an exemplary embodiment of the inventive concept.

Referring to FIG. 2, when inverted F-type array antennas 220 and 230 according to an exemplary embodiment of the inventive concept are disposed on an upper surface of a substrate 210, a right inverted F-type antenna of the first inverted F-type array antenna 220 faces a left inverted F-type antenna of the second inverted F-type array antenna 230. For this reason, at least one slot 240 where at least one capacitor 241 is disposed is formed at a region (e.g., a region between the first and second inverted F-type array antennas 220 and 230) between the plurality of inverted F-type array antennas 220 and 230 of the upper surface of the substrate 210, to separate the inverted F-type array antennas 220 and 230 physically or to prevent interference between the inverted F-type array antennas 220 and 230.

Like a slot where at least one capacitor is disposed (refer to FIG. 1), the slot 240 where the at least one capacitor 241 is disposed generates a resonance frequency equal to a frequency that at least one of the right inverted F-type antenna of the first inverted F-type array antenna 220 or the left inverted F-type antenna of the second inverted F-type array antenna 230 radiates, thereby preventing interference between the inverted F-type array antenna 220 and the second inverted F-type array antenna 230.

At this time, a value and the size of the at least one capacitor 241 and the number of capacitors to be disposed in the slot 240 may be adjusted such that there is generated a resonance frequency equal to a frequency that at least one of the right inverted F-type antenna of the first inverted F-type array antenna 220 or the left inverted F-type antenna of the second inverted F-type array antenna 230 radiates. A depth of the slot 240 where the at least one capacitor 241 is disposed may be also adjusted such that there is generated a resonance frequency equal to a frequency that at least one of the right inverted F-type antenna of the first inverted F-type array antenna 220 or the left inverted F-type antenna of the second inverted F-type array antenna 230 radiates.

Although not shown, a structure where the inverted F-type array antenna is disposed in plurality on an upper surface of a substrate may be applied to various array antennas.

For example, if an array antenna including an antenna such as an inverted L-type antenna is disposed in plurality on an upper surface of a substrate, at least one slot where at least one capacitor is disposed may be formed at a region between plural array antennas such that the array antennas are physically separated.

FIGS. 3 and 4 are cross-sectional views illustrating inverted F-type array antennas disposed in various shapes, according to an exemplary embodiment of the inventive concept.

Referring to FIG. 3, an inverted F-type array antenna according to an exemplary embodiment of the inventive concept is disposed in the form of circle by forming an upper surface of a substrate 310 in a circle. Here, the inverted F-type array antenna disposed in the form of circle may have a structure for isolation improvement shown in FIG. 1.

In the event that a plurality of inverted F-type array antennas 320 and 330 is disposed on a circular upper surface of the substrate 310, at least one slot 340 where at least one capacitor is disposed is formed at a region (e.g., a region between the first inverted F-type array antenna 320 and the second inverted F-type array antenna 330) between plural inverted F-type array antennas 320 and 330 of the circular upper surface of the substrate 310.

Referring to FIG. 4, an inverted F-type array antenna according to an exemplary embodiment of the inventive concept is disposed in the form of polygon by forming an upper surface of a substrate 410 in a polygon. Here, the inverted F-type array antenna disposed in the form of polygon may have a structure for isolation improvement shown in FIG. 1.

In the event that a plurality of inverted F-type array antennas 420 and 430 is disposed on a polygonal upper surface of the substrate 410, at least one slot 440 where at least one capacitor is disposed is formed at a region (e.g., a region between the first inverted F-type array antenna 420 and the second inverted F-type array antenna 430) between plural inverted F-type array antennas 420 and 430 of the polygonal upper surface of the substrate 410.

Accordingly, even though the inverted F-type array antenna is disposed in the form of plane, circle, or polygon, interference between inverted F-type antennas is prevented in the inverted F-type array antenna. In the event that an inverted F-type array antenna is disposed in plurality, interference between inverted F-type array antennas is also prevented.

Although not shown, a structure of an inverted F-type array antenna disposed in the form of plane, circle, or polygon described above may be applied to various array antennas. For example, as disposed on an upper surface of a substrate having a plane, a circle, or a polygon, an array antenna including an antenna such as an inverted L-type antenna may be disposed in the form of plane, circle, or polygon. In this case, interference between antennas is prevented in an array antenna. Even though the array antenna is disposed in plurality, interference between plural array antennas is also prevented.

As described above, embodiments may be described with respect to restricted embodiments and drawings, but it is apparent to one skilled to the art that that change or modification on the embodiments is variously made from the above description. For example, described techniques may be performed in a sequence different from the described method, and/or components such as systems, structures, devices, circuits, etc. may be combined or connected differently from the described method. Although the components are replaced with other components or equivalents, an appropriate result may be achieved.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. An inverted F-type array antenna having a structure for isolation improvement, comprising:
a substrate;
a first inverted F-type antenna formed on an upper surface of the substrate toward a first direction of directions parallel with the upper surface of the substrate; and
a second inverted F-type antenna formed on the upper surface of the substrate toward a second direction, opposite to the first direction, from among the directions parallel with the upper surface of the substrate, so as to be mirrored with respect to the first inverted F-type antenna,
wherein a slot where at least one capacitor for preventing interference between the first inverted F-type antenna and the second inverted F-type antenna is disposed is formed at a region between the first inverted F-type antenna and the second inverted F-type antenna of the upper surface of the substrate.

2. The inverted F-type array antenna of claim 1, wherein the slot where the at least one capacitor is disposed generates a resonance frequency equal to a frequency which at least one of the first inverted F-type antenna or the second inverted F-type antenna radiates, to prevent the interference between the first inverted F-type antenna and the second inverted F-type antenna.

3. The inverted F-type array antenna of claim 2, wherein a value of the at least one capacitor is adjusted such that there is generated a resonance frequency equal to a frequency which at least one of the first inverted F-type antenna or the second inverted F-type antenna radiates.

4. The inverted F-type array antenna of claim 2, wherein at least one of a size of the at least one capacitor or the number of capacitors disposed at the slot is adjusted such that there is generated a resonance frequency equal to a frequency which at least one of the first inverted F-type antenna or the second inverted F-type antenna radiates.

5. The inverted F-type array antenna of claim 2, wherein a depth of the slot where the at least one capacitor is disposed is adjusted such that there is generated a resonance frequency equal to a frequency which at least one of the first inverted F-type antenna or the second inverted F-type antenna radiates.

6. The inverted F-type array antenna of claim 2, wherein the slot where the at least one capacitor is disposed matches impedance between the first inverted F-type antenna and the second inverted F-type antenna.

7. The inverted F-type array antenna of claim 1, wherein when the inverted F-type array antenna is disposed in plurality on the upper surface of the substrate, at least one slot where at least one capacitor is disposed is formed at a region between the plurality of inverted F-type array antennas of the upper surface of the substrate, to separate the plurality of inverted F-type array antennas physically.

8. The inverted F-type array antenna of claim 1, wherein each of the first inverted F-type antenna and the second inverted F-type antenna comprises:
a ground element electrically connected with the substrate;
a feeding element formed to be adjacent to the ground element and configured to transfer a feeding signal; and
a radiation element electrically connected with the ground element and the feeding element, extending in the first direction or the second direction, and configured to radiate a wireless signal.

9. The inverted F-type array antenna of claim 1, wherein the upper surface of the substrate is formed to have a plane, a circle, or a polygon.

10. An array antenna having a structure for isolation improvement, comprising:
a substrate;
a first antenna formed on an upper surface of the substrate toward a first direction of directions parallel with the upper surface of the substrate; and
a second antenna formed on the upper surface of the substrate toward a second direction, opposite to the first direction, from among the directions parallel with the upper surface of the substrate, so as to be mirrored with respect to the first antenna,
wherein a slot where at least one capacitor for preventing interference between the first antenna and the second antenna is disposed is formed at a region between the first antenna and the second antenna of the upper surface of the substrate.

11. The array antenna of claim 10, wherein the slot where the at least one capacitor is disposed generates a resonance frequency equal to a frequency which at least one of the first antenna or the second antenna radiates, to prevent the interference between the first antenna and the second antenna.
